(19) United States
(12) Patent Application Publication
(10) Pub. No.: US 2014/0192521 A1
(43) Pub. Date: Jul. 10, 2014

(54) LIGHT GUIDE ELEMENT

(71) Applicant: LEDIL OY, Salo (FI)

(72) Inventor: Olli-Pekka LAAKKIO, Turku (FI)

(73) Assignee: LEDIL OY, Salo (FI)

(21) Appl. No.: 13/789,939

(22) Filed: Mar. 8, 2013

(30) Foreign Application Priority Data
Jan. 10, 2013 (FI) 20135031

(51) Int. Cl. F21V 8/00; F21S 8/00

(52) U.S. Cl. CPC G02B 6/0036; F21S 8/032
USPC 362/145; 362/341; 362/309; 249/187.1

(57) ABSTRACT

A light guide element (201) for modifying a light distribution pattern of a light source (202) is presented. The light source radiates first light beams to a first quarter-space and second light beams to a second quarter-space, where the first and second quarter-spaces are defined by mutually perpendicular spatial planes and one of the spatial planes constitutes a planar boundary between the first and second quarter-spaces. The light guide element includes transparent material (207) on a route of the first light beams for modifying the light distribution pattern of the first light beams and a reflective surface (208) for reflecting at least a part of the second light beams to the first quarter-space. A surface of solid material on a route of the second light beams includes grooves for spreading the light distribution pattern of the second light beams in the direction of the section line between the spatial planes.

### FIELD OF THE INVENTION

The invention relates generally to illuminating engineering. More particularly, the invention relates to a light guide element for modifying a light distribution pattern of a light source that can be, for example but not necessarily, a light emitting diode “LED”.

### BACKGROUND

Distribution of light produced by a light source can be important or even critical in some applications. The light source can be, for example but not necessarily, a light emitting diode “LED”, a filament lamp, or a gas-discharge lamp. FIG. 1a shows a schematic illustration of a street lightning application where streetlamps 122 and 123 are arranged to illuminate a road 120. FIG. 1b shows a view of a section taken along the line A1-A1 shown in FIG. 1a, and FIG. 1c shows a view of a section taken along the line A2-A2 shown in FIG. 1a. Each of the streetlamps 122 and 123 may comprise, for example, an illuminator device that comprises a plurality of light sources, e.g. light emitting diodes “LED”, and light guide elements each of which being arranged to modify the light distribution pattern of one or more of the light sources. An exemplifying light guide element 101 according to the prior art is illustrated in FIGS. 1e and 1f where FIG. 1f shows a view of a section taken along the line A-A shown in FIG. 1e. A light source 102 is arranged to radiate first light beams to a first quarter-space 103 and second light beams to a second quarter-space 104, where the first and second quarter-spaces are defined by mutually perpendicular spatial planes 105 and 106 so that the spatial plane 105 constitutes a planar boundary between the first and second quarter-spaces. In FIGS. 1e and 1f, some of the first light beams are depicted with dot-and-dash line arrows and some of the second light beams are depicted with dashed line arrows. It is to be noted that the above-mentioned spatial planes 105 and 106 are mere geometrical concepts for illustrative purposes only but not physical elements of the light guide element 101 or of the light source 102. The spatial plane 105 is parallel with the yz-plane of a coordinate system 199 and the spatial plane 106 is parallel with the xy-plane of the coordinate system 199. The light guide element 101 comprises transparent material 107 on the route of the first light beams for modifying a light distribution pattern of the first light beams, where the refractive index of the transparent material is greater than unity. The light guide element 101 comprises a reflective surface 108 for reflecting the second light beams to the first quarter-space 103 as illustrated in FIGS. 1e and 1f. The reflective surface 108 is a surface of a cavity 109. The geometrical forms of the cavity 109 and the refractive index of the transparent material 107 are selected so that the total reflection takes place on the reflective surface 108.

FIG. 1d shows polar plots illustrating simulated luminance distributions on the surface of the road 120 when light guide elements of the kind described above are being used in an exemplifying situation where the distance D between the adjacent streetlamps is about 4.5 times the height H of streetlamp poles and the width W of a lane 121 is about a half of the height H of the streetlamp poles. The solid line polar plot shows the luminance distribution on the line A1-A1 shown in FIG. 1a and the dashed line polar plot shows the luminance distribution on the line A2-A2 that is on the middle of the lane 121. Angle φ₁ is defined in FIG. 1c and angle φ₂ is defined in FIG. 1b. An ideal situation would be such that the luminance is at a suitable level and uniform on the surface of the road. In FIG. 1d, a circle arc 124 illustrates a situation where the luminance is uniformly distributed.

It is inherent that it becomes more and more challenging to achieve a luminance distribution that is sufficiently uniform in the longitudinal direction of the road 120 when the distance D between adjacent streetlamps is increased. On the other hand, the costs of the street lighting can be reduced by increasing the distance D. Thus, there is a clear economic incentive to increase the distance D between adjacent streetlamps.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In accordance with the invention, there is provided a new light guide element for modifying the light distribution pattern of a light source radiating first light beams to a first quarter-space and second light beams to a second quarter-space, the first and second quarter-spaces being defined by mutually perpendicular spatial planes so that one of the spatial planes constitutes a planar boundary between the first and second quarter-spaces. A light guide element according to the invention comprises:
transparent material on a route of the first light beams for modifying the light distribution pattern of the first light beams, a refractive index of the transparent material being greater than unity, and
a reflective surface for reflecting at least a part of the second light beams to the first quarter-space.

A surface of solid material on a route of the second light beams comprises mutually parallel grooves for spreading the light distribution pattern of the second light beams in a direction of a section line between the spatial planes, the grooves being substantially perpendicular to the section line. The fact that the light distribution pattern of the second light beams is spread in the above-described way facilitates achieving, for example, a sufficiently uniform distribution of luminance in the longitudinal direction of a road when the above-described light guide element is used in a street lightning application.

In accordance with the invention, there is provided also a new illuminator device comprising at least one light source and at least one light guide element according to the invention. The at least one light source may comprise, for example, one or more light emitting diodes “LED”.

In accordance with the invention, there is provided also a new system comprising a road and at least one streetlamp comprising at least one illumination device according to the invention, wherein the grooves of the one or more light guide elements of the at least one illumination device are substantially perpendicular to the longitudinal direction of the road.

A light guide element according to an exemplifying and non-limiting embodiment of the invention is a single piece of transparent material that can be manufactured, for example, by mold casting. In accordance with the invention, there is provided also a new mold having a form suitable for manufacturing, by mold casting, the above-mentioned single piece of the transparent material.

A number of exemplifying and non-limiting embodiments of the invention are described in accompanied dependent claims.

Various exemplifying and non-limiting embodiments of the invention both as to constructions and to methods of operation, together with additional objects and advantages thereof, will be best understood from the following description of specific exemplifying embodiments when read in connection with the accompanying drawings.

The verbs “to comprise” and “to include” are used in this document as open limitations that neither exclude nor require the existence of also un-recited features. The features recited in depending claims are mutually freely combinable unless otherwise explicitly stated.

### BRIEF DESCRIPTION OF THE FIGURES

The exemplifying and non-limiting embodiments of the invention and their advantages are explained in greater detail below with reference to the accompanying drawings, in which:

FIGS. 1a, 1b, and 1c shows a schematic illustration of a street lightning application according to the prior art,

FIG. 1d shows polar plots illustrating simulated luminance distributions on the surface of a road shown in FIGS. 1a-1c when light guide elements according to the prior art are being used,

FIGS. 1e and 1f illustrate a light guide element according to the prior art,

FIGS. 2a and 2b illustrate a light guide element according to an exemplifying embodiment of the invention,

FIGS. 3a and 3b illustrate a light guide element according to an exemplifying embodiment of the invention,

FIGS. 4a and 4b illustrate a light guide element according to an exemplifying embodiment of the invention,

FIGS. 5a, 5b, 5c, 5d, and 5e illustrate groove profiles that are applicable in light guide elements according to exemplifying embodiments of the invention,

FIGS. 6a and 6b illustrate an illuminator device according to an exemplifying embodiment of the invention,

FIGS. 7a, 7b, and 7c shows a schematic illustration of a street lightning application employing an illuminator device according to an exemplifying embodiment of the invention, and

FIG. 7d shows polar plots illustrating simulated luminance distributions on the surface of a road shown in FIGS. 7a-7c when light guide elements according to an exemplifying embodiment of the invention are being used.

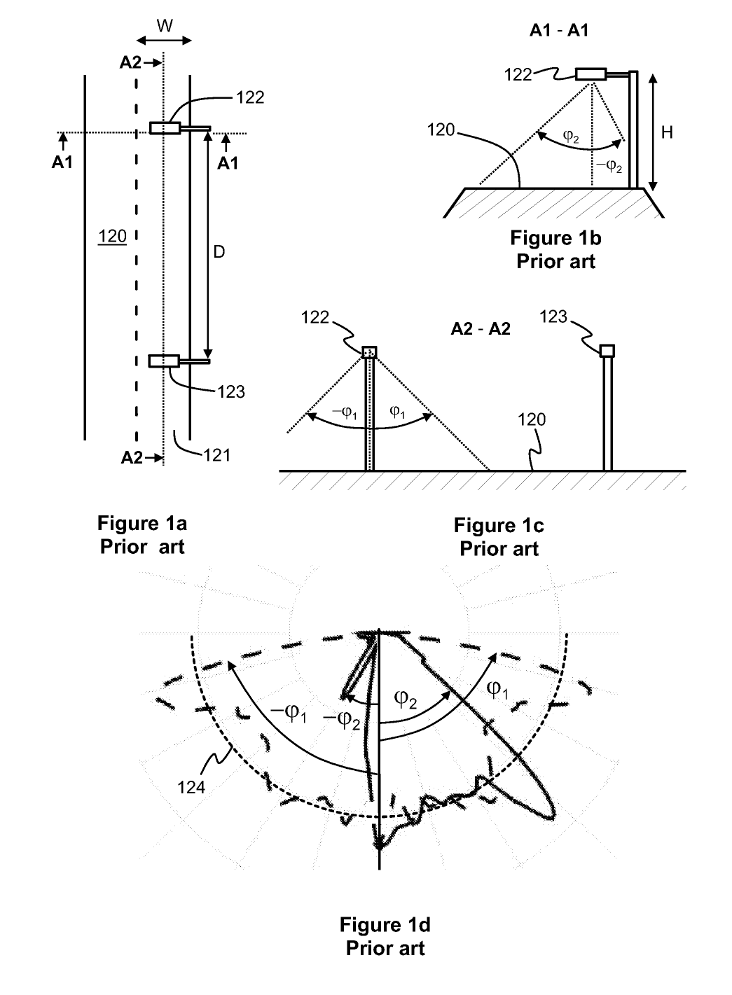

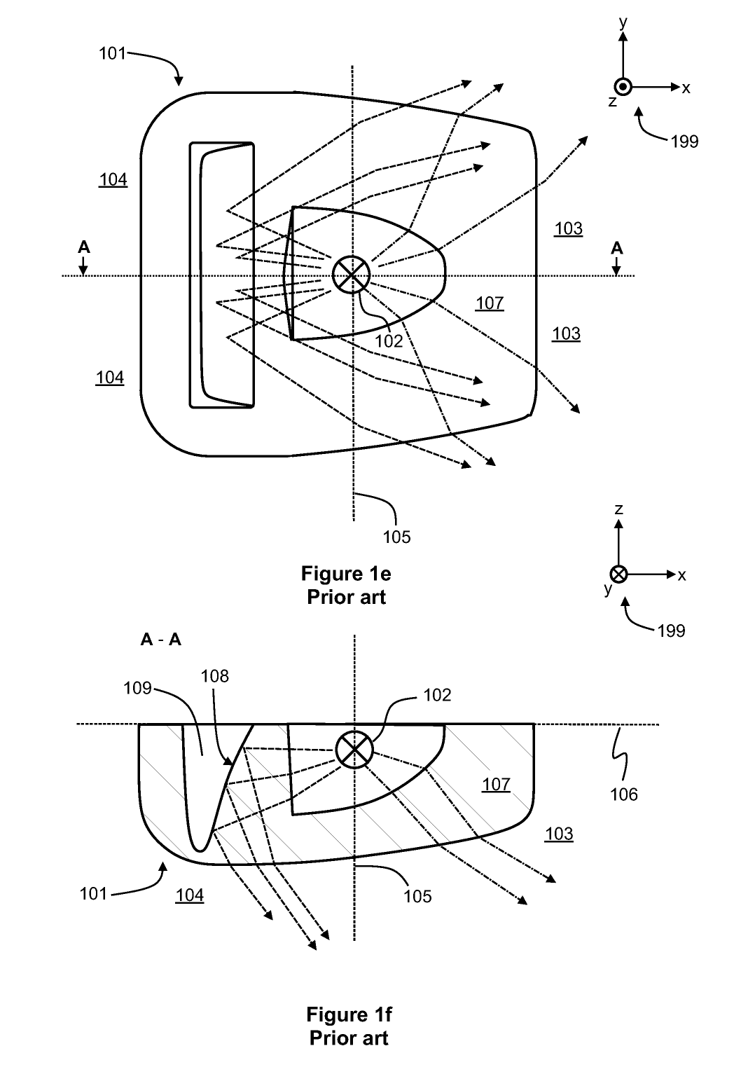

FIGS. 1a-1f have already been explained in the Background-section of this document.

### DESCRIPTION OF EXEMPLIFYING EMBODIMENTS

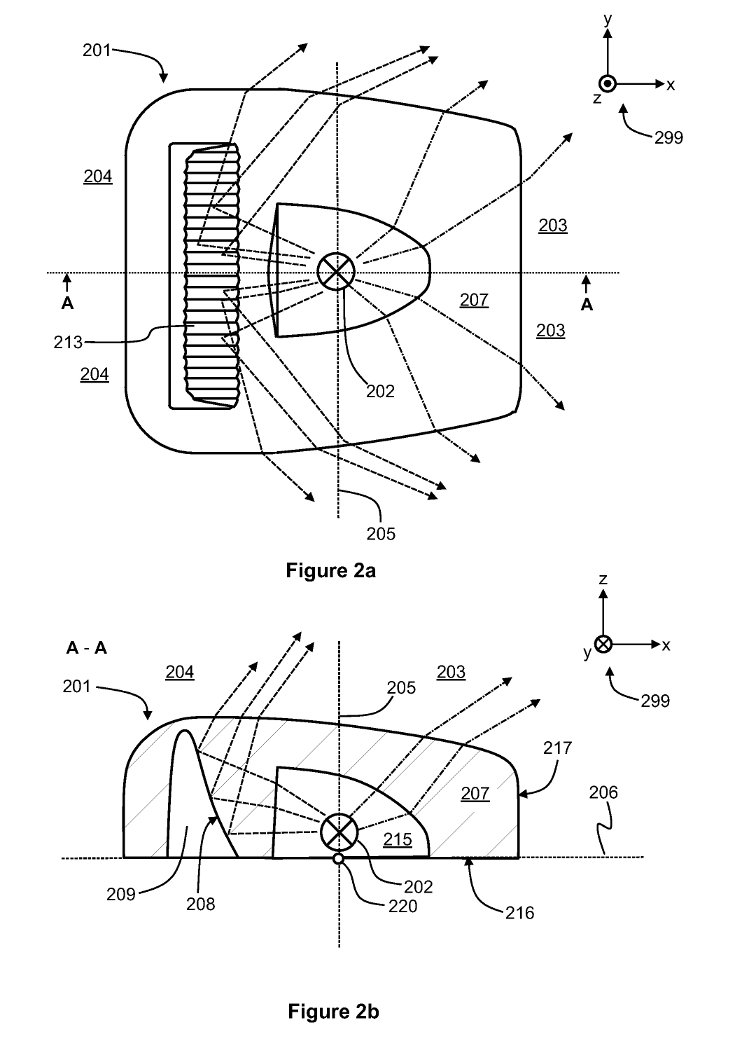

FIGS. 2a and 2b illustrate a light guide element 201 according to an exemplifying embodiment of the invention for modifying the light distribution pattern of a light source 202 that can be, for example but not necessarily, a light emitting diode “LED”, a filament lamp, or a gas-discharge lamp. FIG. 2b shows a view of a section taken along the line A-A shown in FIG. 2a. The light source 202 is arranged to radiate first light beams to a first quarter-space 203 and second light beams to a second quarter-space 204, where the first and second quarter-spaces are defined by mutually perpendicular spatial planes 205 and 206 so that the spatial plane 205 constitutes a planar boundary between the first and second quarter-spaces. In FIGS. 2a and 2b, some of the first light beams are depicted with dot-and-dash line arrows and some of the second light beams are depicted with dashed line arrows. It is to be noted that the above-mentioned spatial planes 205 and 206 are mere geometrical concepts for illustrative purposes only but not physical elements of the light guide element 201 or of the light source 202. The spatial plane 205 is parallel with the yz-plane of a coordinate system 299 and the spatial plane 206 is parallel with the xy-plane of the coordinate system 299.

The light guide element 201 comprises transparent material 207 on the route of the first light beams for modifying the light distribution pattern of the first light beams, where the refractive index of the transparent material is greater than unity.

The transparent material can be, for example, acrylic plastic or glass. The light guide element 201 comprises a reflective surface 208 for reflecting at least a part of the second light beams to the first quarter-space 203 as illustrated in FIGS. 2a and 2b. In addition to the second light beams, the light source 202 may radiate, to the second quarter-space 204, such light beams that do not fall on the reflective surface 208. A surface of solid material on a route of the second light beams comprises mutually parallel grooves 213 for spreading the light distribution pattern of the second light beams in a direction of a section line 220 between the spatial planes 205 and 206. The grooves 213 are substantially perpendicular to the section line 220. In the exemplifying case illustrated in FIGS. 2a and 2b, the grooves 213 are on the reflective surface 208. It is to be noted that the section line 220 is mere geometrical concept for illustrative purposes only but not a physical element of the light guide element 201 or of the light source 202. The section line 220 is parallel with the y-axis of the coordinate system 299. Thus, the grooves 213 on the reflective surface 208 spread the light distribution pattern of the second light beams in the positive and negative y-directions of the coordinate system 299.

In the exemplifying case illustrated in FIGS. 2a and 2b, the light guide element 201 is a single piece of transparent material 207. The piece of transparent material comprises a first cavity 215 for the light source 202 as illustrated in FIG. 2b and a second cavity 209 whose surface constitutes the reflective surface 208 so that a total reflection takes place, as illustrated in FIG. 2b, when the second light beams arrive, from inside the transparent material, at the reflective surface 208 of the second cavity 209. The first and second cavities 215 and 209 are formed so that a first surface 216 of the piece of transparent material comprises pits constituting the first and second cavities and the first surface 216 is substantially planar on regions surrounding the pits, and a second surface 217 of the piece of transparent material has a convex shape surrounding the first and second cavities. The first surface 216 can be installed, for example, against a circuit board where the light source 202 is mounted on a surface of the circuit board. The piece of transparent material constituting the light guide element 201 can be made of, for example, acrylic plastic, polycarbonate, optical silicone, or glass. The method of manufacture can be for example mold casting.

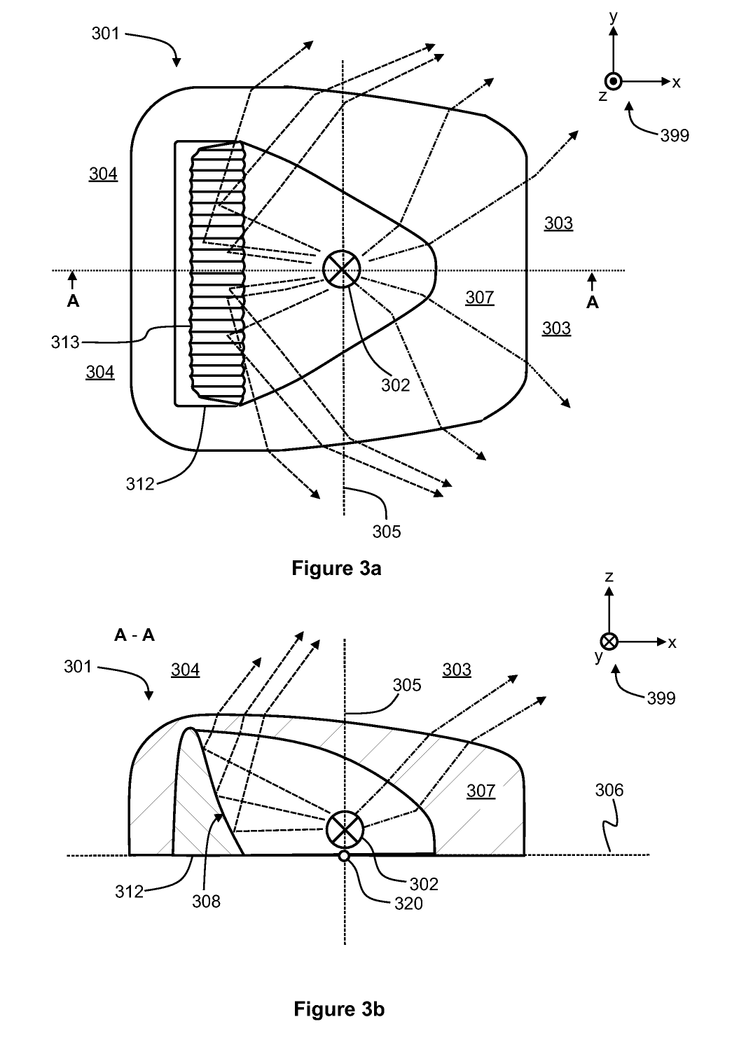

FIGS. 3a and 3b illustrate a light guide element 301 according to another exemplifying embodiment of the invention for modifying the light distribution pattern of a light source 302. FIG. 3b shows a view of a section taken along the line A-A shown in FIG. 3a. The light source 302 is arranged to radiate first light beams to a first quarter-space 303 and second light beams to a second quarter-space 304, where the first and second quarter-spaces are defined by mutually perpendicular spatial planes 305 and 306 so that the spatial plane 305 constitutes a planar boundary between the first and second quarter-spaces. In FIGS. 3a and 3b, some of the first light beams are depicted with dot-and-dash line arrows and some of the second light beams are depicted with dashed line arrows. The light guide element 301 comprises transparent material 307 on the route of the first light beams for modifying the light distribution pattern of the first light beams, where the refractive index of the transparent material is greater than unity. The light guide element 301 comprises a reflective surface 308 for reflecting at least a part of the second light beams to the first quarter-space 303 as illustrated in FIGS. 3a and 3b. In addition to the second light beams, the light source 302 may radiate, to the second quarter-space 304, such light beams that do not fall on the reflective surface 308. The reflective surface is an outer surface of an element 312 that can be, for example, a piece of metal such as aluminum or a piece of plastics coated with a reflective layer. The reflective surface 308 comprises mutually parallel grooves 313 for spreading the light distribution pattern of the second light beams in a direction of a section line 320 between the spatial planes 305 and 306, i.e. in the positive and negative y-directions of a coordinate system 399.

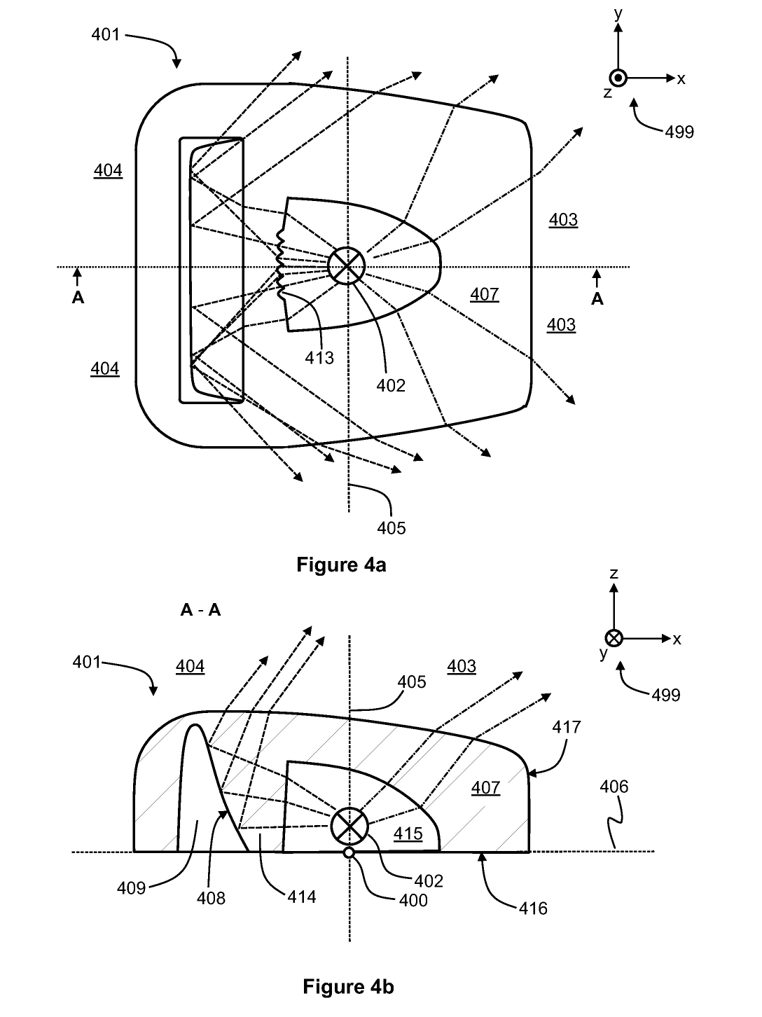

FIGS. 4a and 4b illustrate a light guide element 401 according to an exemplifying embodiment of the invention for modifying the light distribution pattern of a light source 402. FIG. 4b shows a view of a section taken along the line A-A shown in FIG. 4a. The light source 402 is arranged to radiate first light beams to a first quarter-space 403 and second light beams to a second quarter-space 404, where the first and second quarter-spaces are defined by mutually perpendicular spatial planes 405 and 406 so that the spatial plane 405 constitutes a planar boundary between the first and second quarter-spaces. In FIGS. 4a and 4b, some of the first light beams are depicted with dot-and-dash line arrows and some of the second light beams are depicted with dashed line arrows. The light guide element 401 comprises transparent material 407 on the route of the first light beams for modifying the light distribution pattern of the first light beams, where the refractive index of the transparent material is greater than unity. The light guide element 401 comprises a reflective surface 408 for reflecting at least a part of the second light beams to the first quarter-space 403 as illustrated in FIGS. 4a and 4b. In addition to the second light beams, the light source 402 may radiate, to the second quarter-space 404, such light beams that do not fall on the reflective surface 408. The light guide element comprises mutually parallel grooves 413 on a surface of a wall 414 of transparent material as illustrated in FIG. 4a. The wall 414 of transparent material is on the route of the second light beams before the reflective surface 408 as illustrated in FIGS. 4a and 4b. The grooves 413 are arranged to spread, in the positive and negative y-directions of a coordinate system 499, the light distribution pattern of the second light beams falling on the reflective surface 408. It is also possible that there are grooves both on the surface of the wall 414 of transparent material and on the reflective surface 408.

Advantageously, only a middle region of the wall 414 of transparent material is provided with the grooves 413 and the flank regions on both sides of the middle region are free from grooves as illustrated in FIG. 4a. In this case, the light distribution pattern of only those of the second light beams that penetrate the middle region is spread by the grooves. Providing only the middle region with the light spreading grooves 413 reduces the risk that the light distribution pattern of the second light beams is spread so much that too big a portion of the second light beams does not fall on the reflective surface 408.

In the exemplifying case illustrated in FIGS. 4a and 4b, the light guide element 401 is a single piece of transparent material 407. The piece of transparent material comprises a first cavity 415 for the light source 402 as illustrated in FIG. 4b and a second cavity 409 whose surface constitutes the reflective surface 408 so that a total reflection takes place, as illustrated in FIG. 4b, when the second light beams arrive, from inside the transparent material, at the reflective surface 408 of the second cavity 409. The first and second cavities 415 and 409 are formed so that a first surface 416 of the piece of transparent material comprises pits constituting the first and second cavities and the first surface 416 is substantially planar on regions surrounding the pits, and a second surface 417 of the piece of transparent material has a convex shape surrounding the first and second cavities.

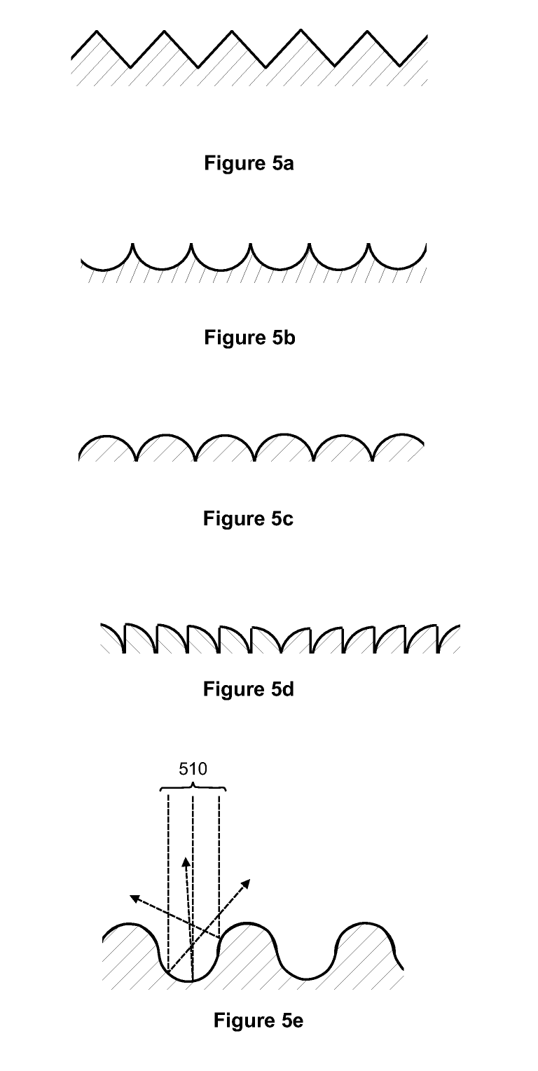

FIGS. 5a, 5b, 5c, 5d, and 5e illustrate groove profiles that are applicable in light guide elements according to exemplifying embodiments of the invention. FIG. 5a illustrates a case where the grooves have a V-shaped profile. FIG. 5b illustrates a case where the grooves have a concave U-shaped profile. FIG. 5c illustrates a case where the ridges between adjacent grooves have a convex U-shaped profile. FIG. 5d illustrates a case where the ridges between adjacent grooves have a quarter-circle profile. FIG. 5e illustrates a case where the grooves have a concave U-shaped profile and the ridges between adjacent grooves have a convex U-shaped profile. Furthermore, FIG. 5e illustrates how grooves spread mutually parallel incident light beams 510. Advantageously, in cases where the reflective surface is provided with the light spreading grooves, the grooves are designed and the reflective surface is positioned with respect to incident light beams so that each of the light beams is reflected only once at the reflective surface so as to minimize reflection losses. Optical designs which fulfill this condition can be found with the aid of simulations.

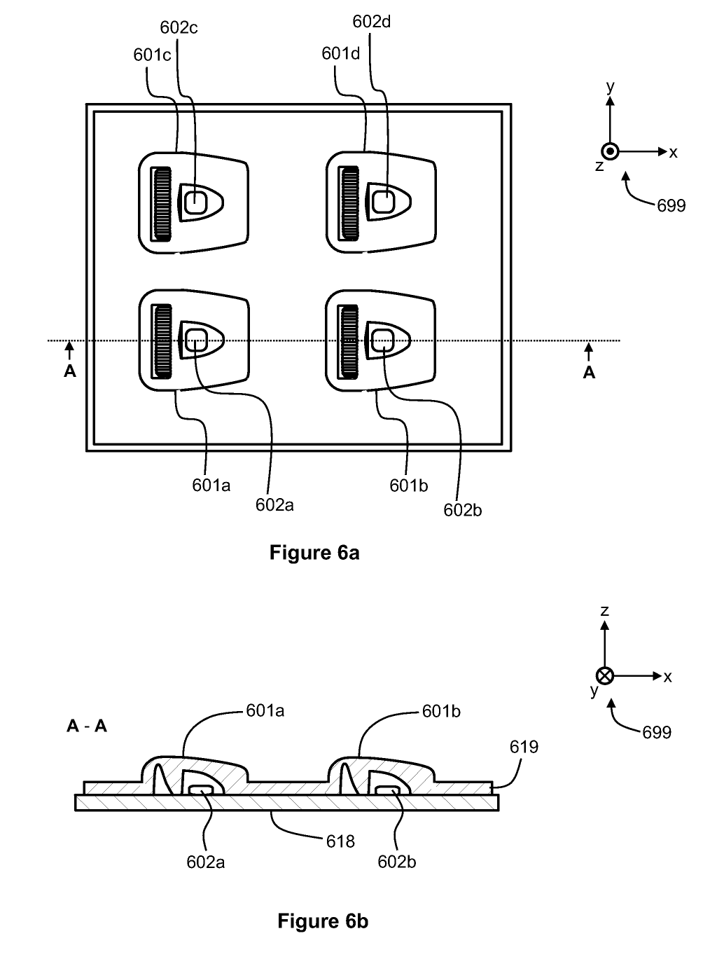

FIGS. 6a and 6b illustrate an illuminator device according to an exemplifying embodiment of the invention. The illuminator device comprises light sources 602a, 602b, 602c and 602d, and light guide elements 601a, 601b, 601c and 601d. Each of the light guide elements is according to an embodiment of the invention. The light guide elements 601a-601d can be, for example, such as illustrated in FIGS. 2a and 2b. Each of the light sources 602a-602d may comprise at least one light emitting diode “LED”. In the exemplifying case illustrated in FIGS. 6a and 6b, the illuminator device further comprises a circuit board 618. The light guide elements 601a-601d are parts of a single piece 619 of transparent material and the light guide elements 601a-601d are mutually parallel. The light sources 602a-602d are located on a surface of the circuit board 618 and in cavities of the light guide elements 601a-601d as illustrated in FIG. 6b.

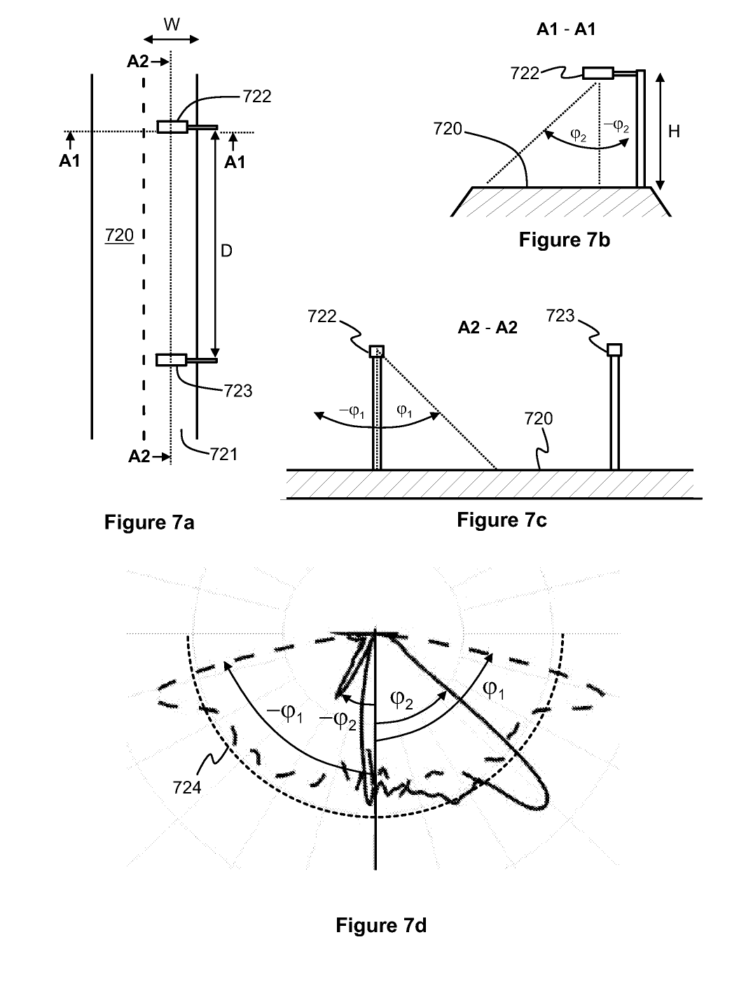

FIG. 7a shows a schematic illustration of a street lightning application where streetlamps 722 and 723 are arranged to illuminate a road 720. FIG. 7b shows a view of a section taken along the line A1-A1 shown in FIG. 7a, and FIG. 7c shows a view of a section taken along the line A2-A2 shown in FIG. 7a. Each of the streetlamps 722 and 723 comprises one or more illuminator devices each of which comprises one or more light sources, e.g. light emitting diodes “LED”, and one or more light guide elements each of which being arranged to modify the light distribution pattern of one light source. Each light guide element can be according to what is illustrated in FIGS. 2a and 2b, or in FIGS. 3a and 3b, or in FIGS. 4a and 4b. The light spreading grooves of the one or more light guide elements are substantially perpendicular to the longitudinal direction of the road 720.

FIG. 7d shows polar plots illustrating simulated luminance distributions on the surface of the road 720 when light guide elements of the kind illustrated in FIGS. 2a and 2b are being used in a similar exemplifying situation as in conjunction with FIG. 1d where the distance D between the adjacent streetlamps is about 4.5 times the height H of streetlamp poles and the width W of a lane 721 is about a half of the height H of the streetlamp poles. The solid line polar plot shows the luminance distribution on the line A1-A1 shown in FIG. 7a and the dashed line polar plot shows the luminance distribution on the line A2-A2 that is on the middle of the lane 721. Angle φ₁ is defined in FIG. 7c and angle φ₂ is defined in FIG. 7b. An ideal situation would be such that the luminance is at a suitable level and uniform on the surface of the road. In FIG. 7d, a circle arc 724 illustrates a situation where the luminance is uniformly distributed. As can be seen, the dashed line polar plot of FIG. 7d does not have such depressions on the ranges φ₁=45° . . . 60° and φ₁=−45° . . . −60° as does the dashed line polar plot of FIG. 1d. Hence, the light spreading grooves of the one or more light guide elements facilitate achieving a sufficiently uniform distribution of luminance in the longitudinal direction of the road.

The specific examples provided in the description given above should not be construed as limiting the scope and/or the applicability of the appended claims. In the above-presented examples, the mutually parallel grooves for spreading light are on or before the reflective surface on the route of the light beams that are reflected by the reflective surface. However, in some cases, the mutually parallel grooves could be on a surface that is after the reflective surface on the route of the light beams that are reflected.

What is claimed is:

1. A light guide element for modifying a light distribution pattern of a light source radiating first light beams to a first quarter-space and second light beams to a second quarter-space, the first and second quarter-spaces being defined by mutually perpendicular spatial planes so that one of the spatial planes constitutes a planar boundary between the first and second quarter-spaces, the light guide element comprising:
transparent material on a route of the first light beams for modifying a light distribution pattern of the first light beams, a refractive index of the transparent material being greater than unity, and
a reflective surface for reflecting at least a part of the second light beams to the first quarter-space,
wherein a surface of solid material on a route of the second light beams comprises mutually parallel grooves for spreading a light distribution pattern of the second light beams in a direction of a section line between the spatial planes, the grooves being substantially perpendicular to the section line.

2. A light guide element according to claim 1, wherein the grooves are on the reflective surface.

3. A light guide element according to claim 1, wherein the light guide element comprises a transparent wall before the reflective surface on the route of the second light beams, and the grooves are on a surface of the transparent wall.

4. A light guide element according to claim 3, wherein a middle region of the transparent wall is provided with the grooves and flank regions on both sides of the middle region are free from grooves.

5. A light guide element according to claim 1, wherein the light guide element comprises a transparent piece comprising a first cavity for the light source and a second cavity whose surface constitutes the reflective surface so that a total reflection takes place when the second light beams arrive, from inside the transparent piece, at the surface of the second cavity.

6. A light guide element according to claim 2, wherein the light guide element comprises a transparent piece comprising a first cavity for the light source and a second cavity whose surface constitutes the reflective surface so that a total reflection takes place when the second light beams arrive, from inside the transparent piece, at the surface of the second cavity.

7. A light guide element according to claim 5, wherein a first surface of the transparent piece comprises pits constituting the first and second cavities and is substantially planar on regions surrounding the pits, and a second surface of the transparent piece has a convex shape surrounding the first and second cavities.

8. A light guide element according to claim 6, wherein a first surface of the transparent piece comprises pits constituting the first and second cavities and is substantially planar on regions surrounding the pits, and a second surface of the transparent piece has a convex shape surrounding the first and second cavities.

9. A light guide element according to claim 5, wherein the transparent piece is made of one of the following: acrylic plastic, polycarbonate, optical silicone.

10. A light guide element according to claim 6, wherein the transparent piece is made of one of the following: acrylic plastic, polycarbonate, optical silicone.

11. A light guide element according to claim 7, wherein the transparent piece is made of one of the following: acrylic plastic, polycarbonate, optical silicone.

12. A light guide element according to claim 1, wherein the grooves have a V-shaped profile.

13. A light guide element according to claim 1, wherein the grooves have a concave U-shaped profile.

14. A light guide element according to claim 1, wherein ridges between adjacent grooves have a convex U-shaped profile.

15. An illuminator device comprising a light source and a light guide element for modifying a light distribution pattern of the light source, the light source radiating first light beams to a first quarter-space and second light beams to a second quarter-space, the first and second quarter-spaces being defined by mutually perpendicular spatial planes so that one of the spatial planes constitutes a planar boundary between the first and second quarter-spaces, and the light guide element comprising:
transparent material on a route of the first light beams for modifying a light distribution pattern of the first light beams, a refractive index of the transparent material being greater than unity, and
a reflective surface for reflecting at least a part of the second light beams to the first quarter-space,
wherein a surface of solid material on a route of the second light beams comprises mutually parallel grooves for spreading a light distribution pattern of the second light beams in a direction of a section line between the spatial planes, the grooves being substantially perpendicular to the section line.

16. An illuminator device according to claim 15, wherein the illuminator device further comprises a circuit board and the light guide element comprises a transparent piece comprising a first cavity for the light source and a second cavity whose surface constitutes the reflective surface so that a total reflection takes place when the second light beams arrive, from inside the transparent piece, at the surface of the second cavity, a first surface of the transparent piece comprising pits constituting the first and second cavities and being substantially planar on regions surrounding the pits, a second surface of the transparent piece having a convex shape surrounding the first and second cavities, and the planar regions of the first surface of the transparent piece being against the circuit board and the light source being in the first cavity.

17. An illuminator device according to claim 16, wherein the illuminator device comprises a plurality of the light guide elements and a plurality of the light sources, the light guide elements being parts of a single piece of the transparent material and the light guide elements being mutually parallel.

18. A mold having a form suitable for manufacturing, by mold casting, a transparent piece of a light guide element that comprises:
transparent material on a route of first light beams for modifying a light distribution pattern of the first light beams, a refractive index of the transparent material being greater than unity and the first light beams being radiated to a first quarter-space, and
a reflective surface for reflecting at least a part of second light beams to the first quarter-space, the second light beams being radiated to a second quarter-space and the first and second quarter-spaces being defined by mutually perpendicular spatial planes so that one of the spatial planes constitutes a planar boundary between the first and second quarter-spaces,
wherein a surface of solid material on a route of the second light beams comprises mutually parallel grooves for spreading a light distribution pattern of the second light beams in a direction of a section line between the spatial planes, the grooves being substantially perpendicular to the section line, and
wherein the transparent piece comprises a first cavity for a light source and a second cavity whose surface constitutes the reflective surface so that a total reflection takes place when the second light beams arrive, from inside the transparent piece, at the surface of the second cavity.

19. A mold according to claim 18 and having a form suitable for manufacturing, by mold casting, the transparent piece of the light guide element, wherein a first surface of the transparent piece comprises pits constituting the first and second cavities and is substantially planar on regions surrounding the pits, and a second surface of the transparent piece has a convex shape surrounding the first and second cavities.

20. A system comprising a road and a streetlamp comprising at least one illumination device comprising a light source and a light guide element for modifying a light distribution pattern of the light source, the light source radiating first light beams to a first quarter-space and second light beams to a second quarter-space, the first and second quarter-spaces being defined by mutually perpendicular spatial planes so that one of the spatial planes constitutes a planar boundary between the first and second quarter-spaces, and the light guide element comprising:
transparent material on a route of the first light beams for modifying a light distribution pattern of the first light beams, a refractive index of the transparent material being greater than unity, and
a reflective surface for reflecting at least a part of the second light beams to the first quarter-space,
wherein a surface of solid material on a route of the second light beams comprises mutually parallel grooves for spreading a light distribution pattern of the second light beams in a direction of a section line between the spatial planes, the grooves being substantially perpendicular to the section line and substantially perpendicular to a longitudinal direction of the road.
